(19) United States
(12) Patent Application Publication
(10) Pub. No.: US 2017/0361989 A1
(43) Pub. Date: Dec. 21, 2017

(54) PRESCRIPTION SLEEVE

(71) Applicant: Frank Wesley Moffett, III, Pittsford, NY (US)

(72) Inventor: Frank Wesley Moffett, III, Pittsford, NY (US)

(21) Appl. No.: 15/411,358

(22) Filed: Jan. 20, 2017

Related U.S. Application Data
(60) Provisional application No. 62/350,961, filed on Jun. 16, 2016.

(51) Int. Cl. B65D 25/20; B65D 50/00; B65D 41/04; B65D 77/04; A61J 1/03

(52) U.S. Cl. CPC B65D 25/205; B65D 77/048; A61J 1/03; B65D 41/04; B65D 50/00

(57) ABSTRACT

A container for medication is provided that has an inner sleeve nested within an outer sleeve. The inner sleeve is retained within the outer sleeve by a ring that engages a lip that is located near a top opening of the outer sleeve. Two labels may be attached to the outer sleeve and inner sleeve, respectively. This effective doubles the surface area for printed information compared to conventional containers of a corresponding size.

### CROSS-REFERENCE TO RELATED APPLICATIONS

This application claims priority to and us a non-provisional of U.S. Patent Application 62/350,961 (filed Jun. 16, 2016), the entirety of which is incorporated herein by reference.

### BACKGROUND OF THE INVENTION

The subject matter disclosed herein relates to the display of information on containers for holding prescription medication. Patients and/or pharmacists generally prefer to use small, unobtrusive containers for their prescription medication. However, governments or other regulatory agencies often require an extensive amount of information to be printed on the labels that are adhered to the containers. In some situations the requirements include not only specific information be printed but further require the information be printed within minimum font sizes. To satisfy these regulations, some pharmacists may provide the prescription medication in containers that are oversized simply so they will be able to use a large label. This causes the patient numerous difficulties. An improved container for prescription medications is therefore desirable. Unfortunately, no container has proven entirely satisfactory.

The discussion above is merely provided for general background information and is not intended to be used as an aid in determining the scope of the claimed subject matter.

### BRIEF DESCRIPTION OF THE INVENTION

A container for medication is provided that has an inner sleeve nested within an outer sleeve. The inner sleeve is retained within the outer sleeve by a ring that engages a lip that is located near a top opening of the outer sleeve. Two labels may be attached to the outer sleeve and inner sleeve, respectively. This effective doubles the surface area for printed information compared to conventional containers of a corresponding size. An advantage that may be realized in the practice of some disclosed embodiments of the prescription sleeve is that additional surface area is provided for attachment of labels. This permits more information to be attached to the prescription sleeve while maintaining relatively small size to the prescription sleeve.

In a first embodiment, a prescription sleeve is provided. The prescription sleeve comprises an outer sleeve comprising a monolithic outer cylindrical container with a first closed bottom, a first open top and a first arcuate vertical wall connecting the first closed bottom to the first open top, the first arcuate vertical wall defining a first cavity with a first diameter and providing a first outer surface for receiving a first label, the first open top being circumscribed by a lip that defines a second diameter that is less than the first diameter; an inner sleeve nested within the first cavity, the inner sleeve comprising a monolithic inner cylindrical container with a second closed bottom, a second open top and a second arcuate vertical wall connecting the second closed bottom and the second open top, the second arcuate vertical wall defining a second cavity with a third diameter and providing a second outer surface for receiving a second label, the second closed bottom being at least partially circumscribed by a ring that defines a fourth diameter that is greater than the second diameter such that the ring engages the lip to retain the ring within the first cavity; wherein the inner sleeve slides within the outer sleeve such that the second arcuate vertical wall can be extended outside of the first open top.

In a second embodiment, a prescription sleeve is provided. The prescription sleeve comprises an outer sleeve comprising a monolithic outer cylindrical container with a first closed bottom, a first open top and a first arcuate vertical wall connecting the first closed bottom to the first open top, the first arcuate vertical wall defining a first cavity with a first diameter and providing a first outer surface having a first label, the first open top being circumscribed by a lip that defines a second diameter that is less than the first diameter; an inner sleeve nested within the first cavity, the inner sleeve comprising a monolithic inner cylindrical container with a second closed bottom, a second open top and a second arcuate vertical wall connecting the second closed bottom and the second open top, the second arcuate vertical wall defining a second cavity with a third diameter and providing a second outer surface having a second label, the second closed bottom is fully circumscribed by a ring that defines a fourth diameter that is greater than the second diameter such that the ring engages the lip to retain the ring within the first cavity; a turn stop formed by an interior ledge formed on the first closed bottom on the outer sleeve and a protrusion formed on the second closed bottom on the inner sleeve, wherein rotation of the inner sleeve within the outer sleeve is (1) prevented when the interior ledge engages the protrusion and (2) permitted when the interior ledge does not engage the protrusion; and wherein the inner sleeve slides within the outer sleeve such that the second arcuate vertical wall can be extended outside of the first open top.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A is a top perspective view of a prescription sleeve in a collapsed state;

FIG. 1B is an exploded perspective view of the prescription sleeve;

FIG. 1C is an to perspective view of a prescription sleeve in an extended state;

FIG. 2A is a top view of the prescription sleeve;

FIG. 2B is a cross section view of the prescription sleeve taken along line A-A of FIG. 2A;

FIG. 3A is a top perspective, phantom view of an outer sleeve of the prescription sleeve;

FIG. 3B is a top view of the outer sleeve of the prescription sleeve;

FIG. 3C is a cross section view of the outer sleeve taken along line B-B of FIG. 3B;

FIG. 4A is a bottom perspective view of an inner sleeve of the prescription sleeve;

FIG. 4B is a bottom view of the inner sleeve;

FIG. 4C is a cross section view of the inner sleeve taken along line C-C of FIG. 4B;

FIG. 5A is a bottom view of the inner sleeve showing a turn stop while FIG. 5B is a top view of the outer sleeve showing the turn stop;

FIG. 6A is a bottom view of another embodiment of an inner sleeve showing a turn stop while FIG. 6B is a top view of the outer sleeve showing the turn stop; and

FIG. 7 is a top perspective view of another embodiment of an inner sleeve showing another turn stop.

### DETAILED DESCRIPTION OF THE INVENTION

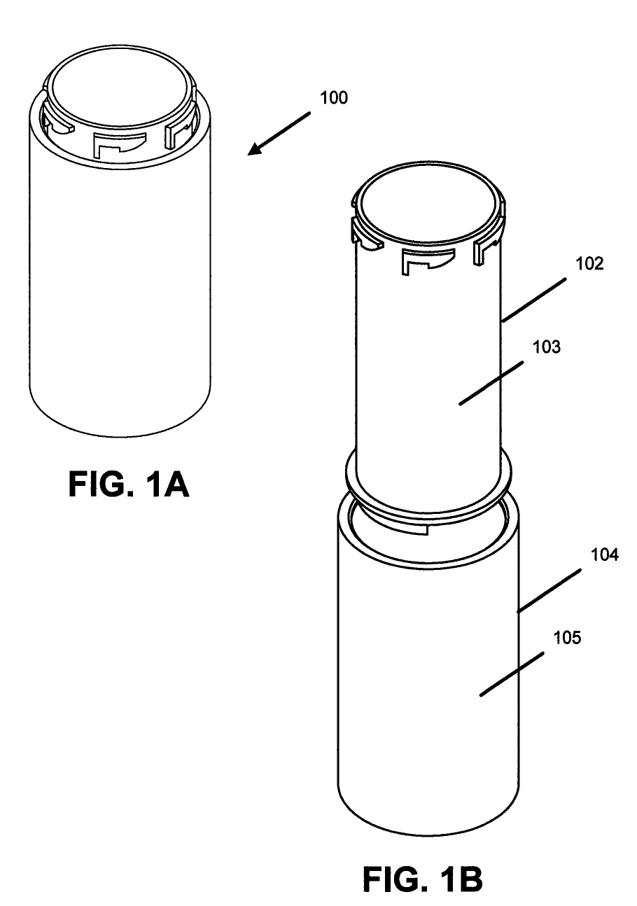

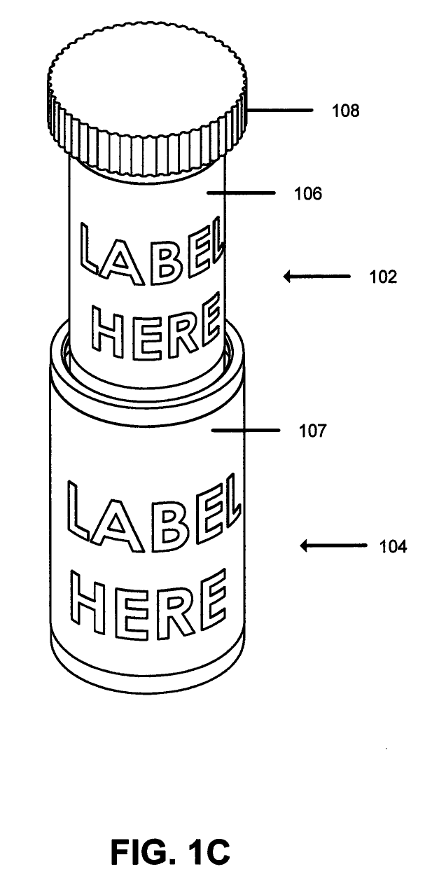

FIG. 1A depicts a prescription sleeve 100. As shown in FIG. 1B, the prescription sleeve 100 comprises an inner sleeve 102 that is nested within an outer sleeve 104. The inner sleeve and outer sleeve can be formed by conventional methods from polymeric materials. Such methods include, for example, injection molding. In the embodiment of FIG. 1A and FIG. 1B both the inner sleeve 102 and the outer sleeve 104 are cylindrical. The outer sleeve 104 presents a surface 105 on its outside where a first label may be adhered. The inner sleeve 102 likewise presents a surface 103 where a second label may be adhered. In use, certain information (e.g. name of patient, name of drug, dosage instructions, etc.) can be printed on the first label whereas other information (e.g. side effects, etc.) can be printed on the second label. If the patient wants to access the other information on the second label, the patient only needs to pull on the top or the lid of the inner sleeve 102 to extend the inner sleeve 102 outside of the outer sleeve 104 and thereby read the second label. The bottles (sleeves) do not completely separate, but slide apart far enough so that both labels are completely visible. Such a configuration provides more than double the surface area for attachment of labels compared to a traditional container which only has a single surface while still using a total volume defined by the outer sleeve 104. FIG. 1C depicts a top perspective view of a prescription sleeve in use. The inner sleeve 102 has a first label 106 while the outer sleeve 104 has a second label 107. The prescription sleeve also has a lid 108 that attaches to the inner sleeve 102.

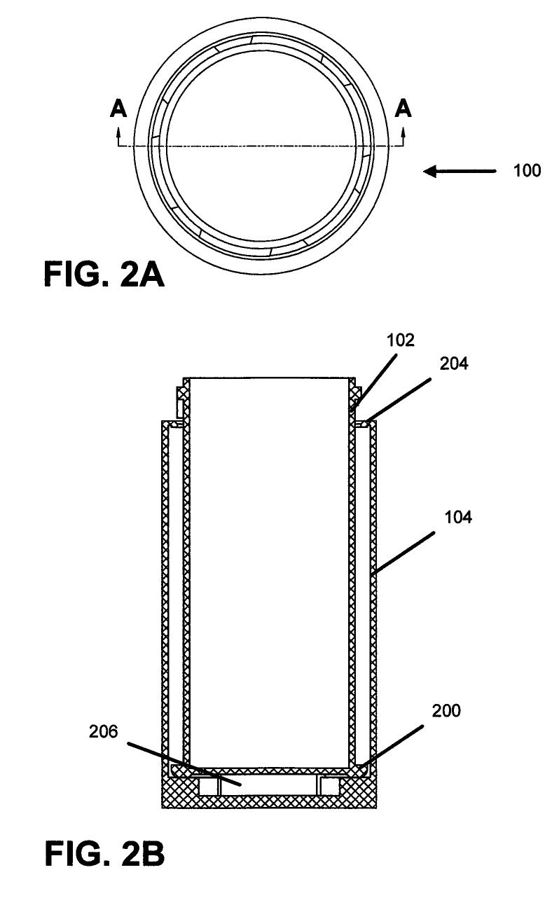

FIG. 2A is a top view of the prescription sleeve 100 depicting a line A-A. FIG. 2B is a cross section view of the prescription sleeve 100 taken along the line A-A. The inner sleeve 102 has a ring 200 along the exterior of its bottom side that engages a lip 204 (on the outer sleeve 104) such that the inner sleeve 102 does not accidently fall out of the outer sleeve 104. In the embodiment of FIG. 2A, the ring 200 is monolithic with respect to the inner sleeve 102. The ring 200 on the inner sleeve 102 is slightly wider than the lip 204 on the outer sleeve 104 to prevent the inner sleeve 102 from accidently sliding out of the outer sleeve 104. In some embodiments, the inner sleeve 102 and/or the outer sleeve 104 is formed of a semi-flexible material, such as a plastic, that permits the ring 200 to be slightly compressed and pass by the lip 204. In one embodiment, the lip 204 on the outer sleeve 104 is angled to be slightly wider at the bottom of the lip 204 than at top of the lip 204. This promotes one way travel because the inner sleeve 102 can pass down into outer sleeve 104, but resists passing up. Alternatively or additionally, the ring 200 can likewise be slightly wider at the top of the ring 200 than at the bottom of the ring 200. Other possible shapes for the ring 200 and the lip 204 include rounded (fillet) or half rounded at the top or bottom half of the ring.

The inner sleeve 102 and the outer sleeve 104 jointly provide a turn stop 206 (described in further detail elsewhere in this specification). The turn stop 206 rotationally locks the inner sleeve 102 in the outer sleeve 104 such that the user can fasten and remove a screw-top lid (e.g. a childproof lid) on the inner sleeve 102 by preventing the inner sleeve 102 from inappropriately rotating.

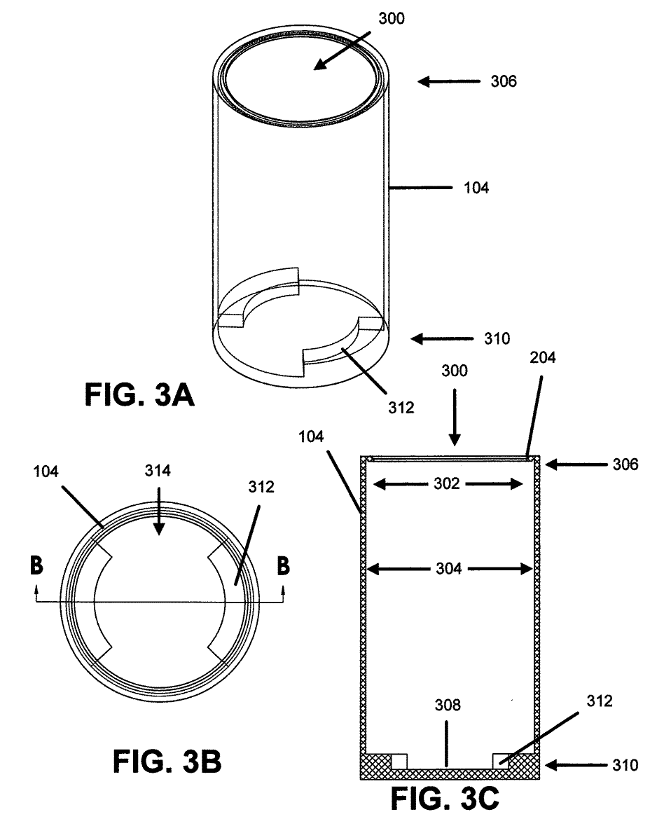

FIG. 3A, FIG. 3B and FIG. 3C depict the outer sleeve 104 in further detail. FIG. 3A is a top perspective view of the outer sleeve 104 with the interior features shown in phantom for clarity of illustration. FIG. 3B is a top view of the outer sleeve 104 depicting a line B-B. FIG. 3C is a cross section view of the outer sleeve 104 taken along the line B-B. The outer sleeve 104 comprises an opening 300 at its top end 306 that is circumscribed by the lip 204. The lip 204 defines a narrow diameter 302 which is less than the diameter 304 of the outer sleeve 104. The outer sleeve 104 further comprises a closed bottom 308 at its bottom end 310. The bottom end 310 further comprises at least one interior ledge 312 that is part of the turn stop 206. In the example depicted in the figures, two such interior ledges are shown, however another option is to have more than two, or just one. The interior ledge 312 is disposed on the closed bottom 308 and partially circumscribes the circumference of the closed bottom 308 such that at least one space 314 is present. The space 314 receives a corresponding protrusion (e.g. protrusion 412) on the inner sleeve 102.

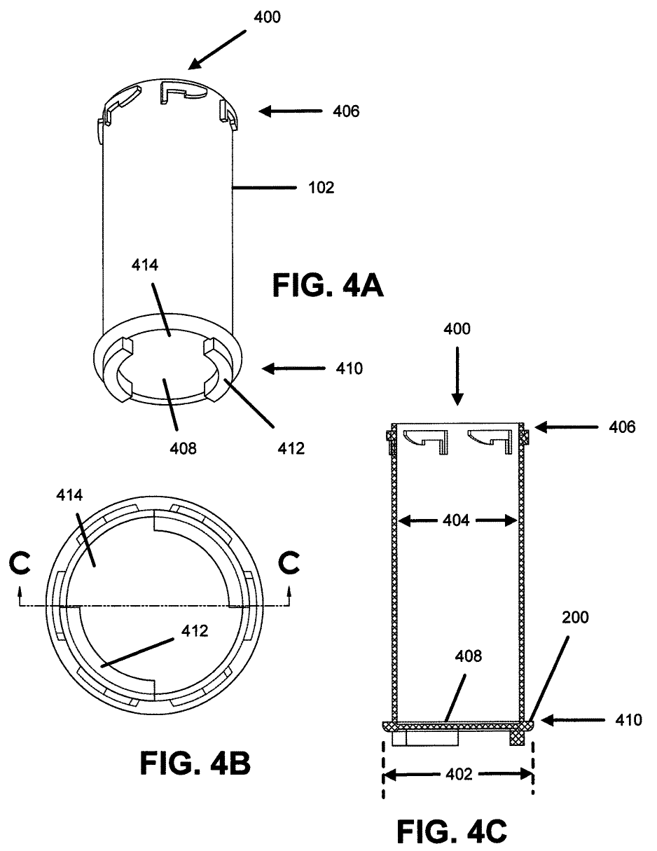

FIG. 4A, FIG. 4B and FIG. 4C depict the inner sleeve 102 in further detail. FIG. 4A is a bottom perspective view of the inner sleeve 102. FIG. 4B is a top view of the inner sleeve 102 depicting a line C-C. FIG. 4C is a cross section view of the inner sleeve 102 taken along the line C-C. The inner sleeve 102 comprises an opening 400 at its top end 406. The inner sleeve 102 further comprises a closed bottom 408 at its bottom end 410. The ring 200 is on an external surface of the inner sleeve 102 and defines a wide diameter 402 which is greater than the diameter 404 of the inner sleeve 102. To provide sufficient volume to hold medication within the inner sleeve 102 the diameter 404 is substantially similar to the diameter 304 of the outer sleeve 104. In one embodiment, the diameter 404 is at least 70% of the diameter 304. In another embodiment, the diameter 404 is at least 80% of the diameter 304. The bottom end 410 further comprises at least one protrusion 412 that is part of the turn stop 206. In the example depicted in the figures, two such protrusions are shown. The protrusion 412 is disposed on the closed bottom 408 and partially circumscribes the circumference of the closed bottom 408 such that at least one space 414 is present. The space 414 receives a corresponding interior ledge (e.g. interior ledge 312) on the outer sleeve 104. The lid receptacle 416 is disposed on the external vertical side of the inner sleeve 102 for attaching a lid (not shown). In the embodiment depicted in the figures, the lid receptacle 416 is a plurality of grooved hooks for attaching a child-proof lid. In another embodiment, the lid receptacle is a threaded surface for receiving a screw-top lid.

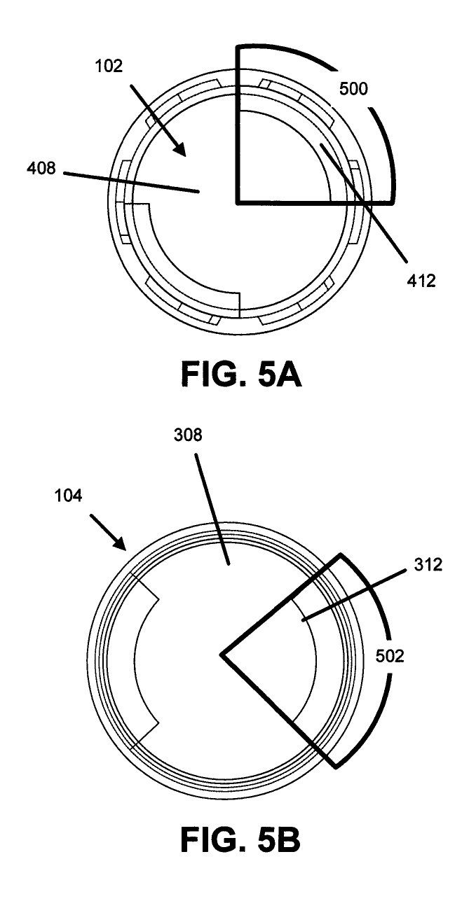

FIG. 5A and FIG. 5B depict the turn stop 206 in further detail. In FIG. 5A the protrusion 412 partially circumscribes the circumference of the closed bottom 408 such that vertical edges of the protrusion 412 form an angle 500. In the embodiment of FIG. 5A there are two protrusions 412 and the angle 500 is about 90°. In FIG. 5B the interior ledge 312 partially circumscribes the circumference of the closed bottom 308 such that vertical edges of the interior ledge 312 form an angle 502. In the embodiment of FIG. 5B the angle 502 is about 86°. In one embodiment, the angle 500 and 502 are different such that the sum of all of the angles is less than 360°. Such a configuration provides a small gap that helps the protrusion 412 fit within the space 314. In one embodiment, the sum of all of the angles is greater than 340° but less than 360°. In another embodiment, the sum of all of the angles is greater than 350° but less than 360°. For example, when two protrusions 412 with 90° angles and two interior ledges 312 with 86° degree angles are present, the sum of all of the angles is 352°. In one embodiment, the sum of all of the angles is less than 360°. Almost any total amount of angles between 0 and 360 degrees is possible.

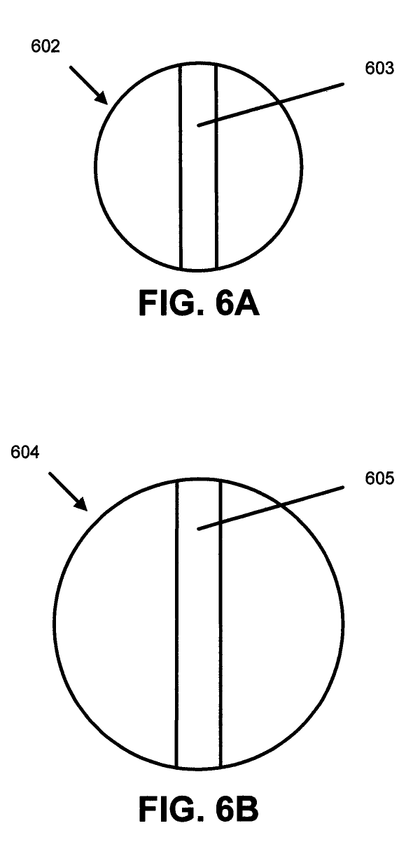

FIG. 6A and FIG. 6B depicts an alternative turn stop with an inner sleeve 602 and an outer sleeve 604. In the embodiment depicted, a recessed groove 605 is present on the outer sleeve 604 that receives a raised ridge 603. In another embodiment (not shown), the recessed groove 605 is on the inner sleeve 602 and the raised ridge 603 is on the outer sleeve 604. The example depicted illustrates a single elongated recessed groove 605 and a single raised ridge 603 but other configures would be apparent to those skilled in the art after benefiting from reading this disclosure. Such alternative configurations include, but are not limited to, a plurality of raised ridges and recessed grooves, and ridges/grooves with various shapes (e.g. dimples, various shapes, etc.).

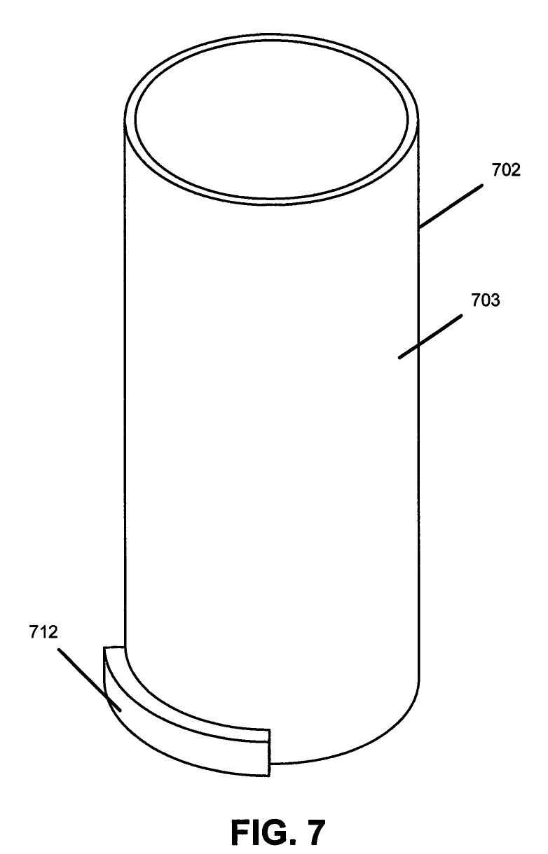

FIG. 7 depicts another turn stop. In FIG. 7, an inner sleeve 702 with an interior ledge 712 on a vertical surface 703. The inner sleeve 702 is configured to mate with a corresponding outer sleeve that is similar to the outer sleeve 104. The interior ledge 712 mates with a space on the corresponding outer sleeve where the space is similar to the space 314 of the outer sleeve 104. In the embodiment of FIG. 7, a single interior ledge 712 is shown. In other embodiments, more than one interior ledge is present.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A prescription sleeve comprising:
an outer sleeve comprising a monolithic outer cylindrical container with a first closed bottom, a first open top and a first arcuate vertical wall connecting the first closed bottom to the first open top, the first arcuate vertical wall defining a first cavity with a first diameter and providing a first outer surface for receiving a first label, the first open top being circumscribed by a lip that defines a second diameter that is less than the first diameter;
an inner sleeve nested within the first cavity, the inner sleeve comprising a monolithic inner cylindrical container with a second closed bottom, a second open top and a second arcuate vertical wall connecting the second closed bottom and the second open top, the second arcuate vertical wall defining a second cavity with a third diameter and providing a second outer surface for receiving a second label, the second closed bottom being at least partially circumscribed by a ring that defines a fourth diameter that is greater than the second diameter such that the ring engages the lip to retain the ring within the first cavity; and
wherein the inner sleeve slides within the outer sleeve such that the second arcuate vertical wall can be extended outside of the first open top.

2. The prescription sleeve as recited in claim 1, wherein the inner sleeve and the outer sleeve both consist of a plastic.

3. The prescription sleeve as recited in claim 1, wherein the inner sleeve and the outer sleeve both consist of polyethylene.

4. The prescription sleeve as recited in claim 1, wherein the lip is angled such that the lip is wider at a bottom of the lip than at a top of the lip.

5. The prescription sleeve as recited in claim 1, wherein the ring is angled such that the ring is wider at a top of the ring than at a bottom of the ring.

6. The prescription sleeve as recited in claim 1, further comprising a lid that engages the second open top of the inner sleeve.

7. The prescription sleeve as recited in claim 1, further comprising a turn stop formed by an interior ledge formed on the first closed bottom on the outer sleeve and a protrusion formed on the second closed bottom on the inner sleeve, wherein rotation of the inner sleeve within the outer sleeve is (1) prevented when the interior ledge engages the protrusion and (2) permitted when the interior ledge does not engage the protrusion.

8. The prescription sleeve as recited in claim 7, wherein the first closed bottom on the outer sleeve comprises at least two interior ledges separated by a space, wherein the protrusion fits between the at least two interior ledges and within the space when the rotation of the inner sleeve within the outer sleeve is being prevented.

9. The prescription sleeve as recited in claim 1, wherein the third diameter of the second cavity is at least 70% of the first diameter of the first cavity.

10. The prescription sleeve as recited in claim 1, wherein the ring fully circumscribes the second closed bottom.

11. A prescription sleeve comprising:
an outer sleeve comprising a monolithic outer cylindrical container with a first closed bottom, a first open top and a first arcuate vertical wall connecting the first closed bottom to the first open top, the first arcuate vertical wall defining a first cavity with a first diameter and providing a first outer surface having a first label, the first open top being circumscribed by a lip that defines a second diameter that is less than the first diameter;
an inner sleeve nested within the first cavity, the inner sleeve comprising a monolithic inner cylindrical container with a second closed bottom, a second open top and a second arcuate vertical wall connecting the second closed bottom and the second open top, the second arcuate vertical wall defining a second cavity with a third diameter and providing a second outer surface having a second label, the second closed bottom is fully circumscribed by a ring that defines a fourth diameter that is greater than the second diameter such that the ring engages the lip to retain the ring within the first cavity;
a turn stop formed by an interior ledge formed on the first closed bottom on the outer sleeve and a protrusion formed on the second closed bottom on the inner sleeve, wherein rotation of the inner sleeve within the outer sleeve is (1) prevented when the interior ledge engages the protrusion and (2) permitted when the interior ledge does not engage the protrusion; and
wherein the inner sleeve slides within the outer sleeve such that the second arcuate vertical wall can be extended outside of the first open top.

12. The prescription sleeve as recited in claim 11, wherein the third diameter of the second cavity is at least 70% of the first diameter of the first cavity.

13. The prescription sleeve as recited in claim 11, further comprising a lid that engages the second open top of the inner sleeve.

14. The prescription sleeve as recited in claim 11, wherein the first closed bottom on the outer sleeve comprises at least two interior ledges separated by a space, wherein the protrusion fits between the at least two interior ledges and within the space when the rotation of the inner sleeve within the outer sleeve is being prevented.
